(19) United States
(12) Patent Application Publication
(10) Pub. No.: US 2020/0239284 A1
(43) Pub. Date: Jul. 30, 2020

(54) AUTOMATED LIFTING HOOK APPARATUS WITH GUIDE

(71) Applicant: Shane Bakalyar, Murfreesboro, TN (US)

(72) Inventor: Shane Bakalyar, Murfreesboro, TN (US)

(21) Appl. No.: 16/776,785

(22) Filed: Jan. 30, 2020

Related U.S. Application Data
(60) Provisional application No. 62/798,524, filed on Jan. 30, 2019.

(51) Int. Cl. B66C 1/36

(52) U.S. Cl. CPC B66C 1/36

(57) ABSTRACT

An automated lifting hook apparatus which includes a hook housing and a hook member movably connected to the hook housing, the hook member moveable between a retracted position and a hook position, the hook member defining a hook engagement point when the hook member is in the hook position. A guide frame can be connected to the hook housing, the guide frame including at least one guide plate extending outward relative to the hook engagement point of the hook member in a first direction and at a downward angle. In some embodiments, the guide frame can include a plurality of guide plates extending radially outward from the hook engagement point at respective downward angles.

### CROSS-REFERENCES TO RELATED APPLICATIONS

This application is a non-provisional of U.S. Patent Application No. 62/798,524 filed Jan. 30, 2019 entitled AUTOMATED LIFTING HOOK APPARATUS WITH GUIDE, which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to lifting hook applications.

More particularly, the present disclosure relates to automated lifting hook devices such as an Elebia® hook that has an automated hook member movable between a retracted and a hooked position. Automated lifting hooks in some embodiments can include a magnet or electromagnet that can be utilized to attract a metal object such as an eyelet or lifting ring attached to a load for lifting the load. The magnet can be utilized to grab the eyelet and the automated lifting hook can be actuated to move the hook member to the hook position to engage the eyelet for lifting the load. Such automated hooks can be utilized to remove the need for a lift operator to manually connect the lift hook to a lifting ring or lifting eyelet on an object to be lifted.

Conventional automated lifting hooks have a target area on the hook that must be adjacent the eyelet or lifting ring on the object to be lifted in order to ensure proper engagement of the hook member when actuated, which can be the magnet or electromagnet, that is relatively small. As such, conventional systems provide a small target area for an operator to land the lifting hook as the operator is attempting to acquire the eyelet or lifting ring with the automated lifting hook. Target areas, including conventional magnets or electromagnets, can provide a target area of only a few square inches, making capture of the eyelet or lifting ring difficult for the crane operator.

What is needed then are improvements to automated lifting hooks.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is an automated lifting hook apparatus which includes a hook housing and a hook member movably connected to the hook housing, the hook member moveable between a retracted position and a hook position, the hook member defining a hook engagement point when the hook member is in the hook position. A guide frame can be connected to the hook housing, the guide frame including at least one guide plate extending outward relative to the hook engagement point of the hook member in a first direction and at a downward angle. In some embodiments, the guide frame can include a plurality of guide plates extending radially outward from the hook engagement point at respective downward angles.

As the automated lifting hook is lowered down toward an eyelet or lifting ring on a load or object to be lifted, if the automated lifting hook is slightly off target, the eyelet or lifting ring can engage the at least one angled guide plate on the guide frame, the angled guide plate forcing the eyelet or lifting ring toward the hook engagement point, or the hook engagement point of the lifting hook apparatus toward the lifting eyelet or lifting ring as the automated lifting hook is further lowered onto the eyelet or lifting ring such that the eyelet or lifting ring can be positioned near the hook engagement point. With the eyelet or lifting ring near the hook engagement point, the hook member can engage the eyelet or lifting ring as the hook member moves to the hook position and the automated lifting hook is raised by a crane or other lifting device. In some embodiments, the automated lifting hook can include a magnetic member positioned proximate the hook engagement point, and the at least one plate of the guide frame can extend outward and at a downward angle from the magnetic member.

The guide frame with guide plates contemplated in this disclosure can help provide for a larger potential landing area or target area for a crane operator. If the lifting hook is offset from the lifting eyelet or lifting ring, the at least one guide plate can effectively cause the lifting hook apparatus to move to an appropriate position over the lifting ring or lifting eyelet. In some embodiments, angled guide plates can extend both in a longitudinal direction and in a lateral direction with respect to the hook engagement point of the hook housing.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of an automated lifting hook apparatus of the present disclosure including at least one guide plate extending outward and in a downward direction relative to a hook engagement point and/or a hook housing of the apparatus.

FIG. 2 is a bottom perspective view of the automated lifting hook apparatus of FIG. 1.

FIG. 3 is a side view of the automated lifting hook apparatus of FIG. 1 showing a hook member in a hook position.

FIG. 4 is a side view of the automated lifting hook apparatus of FIG. 3 showing a hook member in a retracted position.

FIG. 5 is a partial perspective view of the automated lifting hook apparatus of FIG. 1 positioned over a lifting eyelet or lifting ring of an object to be lifted.

FIG. 6 is a side view of the lifting hook apparatus of FIG. 5 being lowered onto the lifting eyelet or lifting ring such that the lifting eyelet or lifting ring contacts or engages the guide plate of the apparatus

FIG. 7 is a side view of the lifting hook apparatus of FIG. 6 being further lowered and the guide plate forcing the apparatus to move relative to the lifting eyelet or lifting ring to force a hook engagement point of the apparatus toward the lifting eyelet or lifting ring.

FIG. 8 is a side view of the lifting hook apparatus of FIG. 8 showing the hook member moving from the retracted position to the hook position to engage the lifting eyelet or lifting ring as the lifting hook apparatus is lifted by a lifting device such as a crane.

FIG. 9 is a perspective view of another embodiment of a lifting hook apparatus of the present disclosure included a camera mounted to a guide plate of the lifting apparatus, the camera oriented to view the hook engagement point of the apparatus.

FIG. 10 is a front elevation view of another embodiment of an automated lifting apparatus of the present disclosure including both longitudinally and laterally extending guide plates.

FIG. 11 is a top view of the lifting hook apparatus of FIG. 10.

FIG. 12 is a side view of the lifting hook apparatus of FIG. 10 being lowered onto a lifting eyelet or lifting ring of a load or object to be lifted.

FIG. 13 is a side view of the lifting hook apparatus of FIG. 12 being further lowered and the lateral guide plate forcing the apparatus to move laterally relative to the lifting eyelet or lifting ring to force a hook engagement point of the apparatus toward the lifting eyelet or lifting ring.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” “Upward,” “downward” etc. refer to the apparatus when in the orientation shown in the drawing. A person of skill in the art will recognize that the apparatus can assume different orientations when in use.

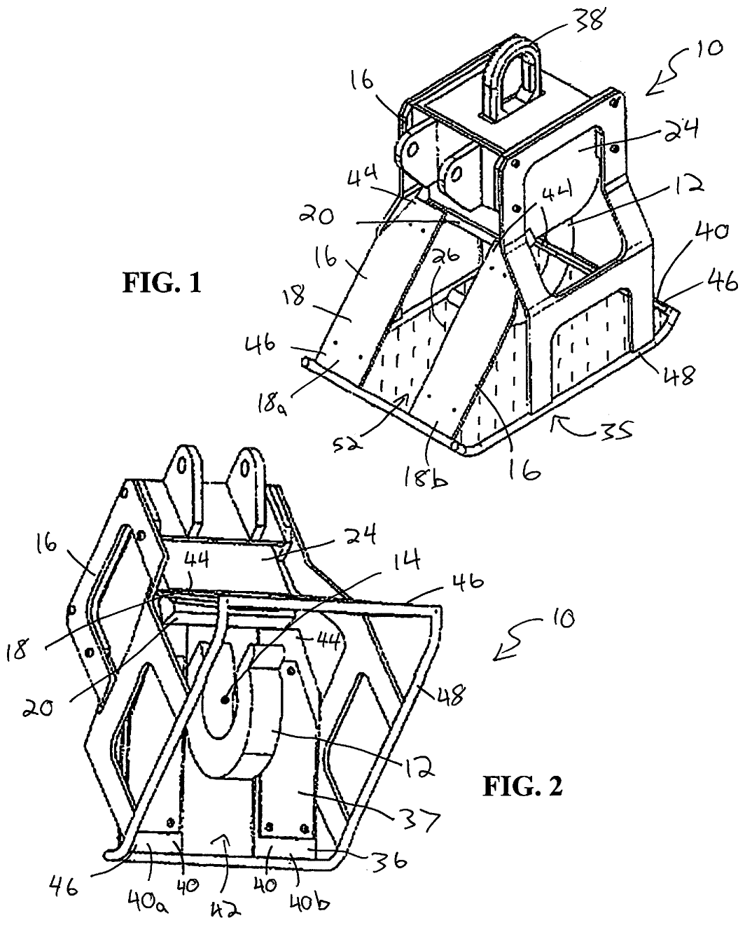

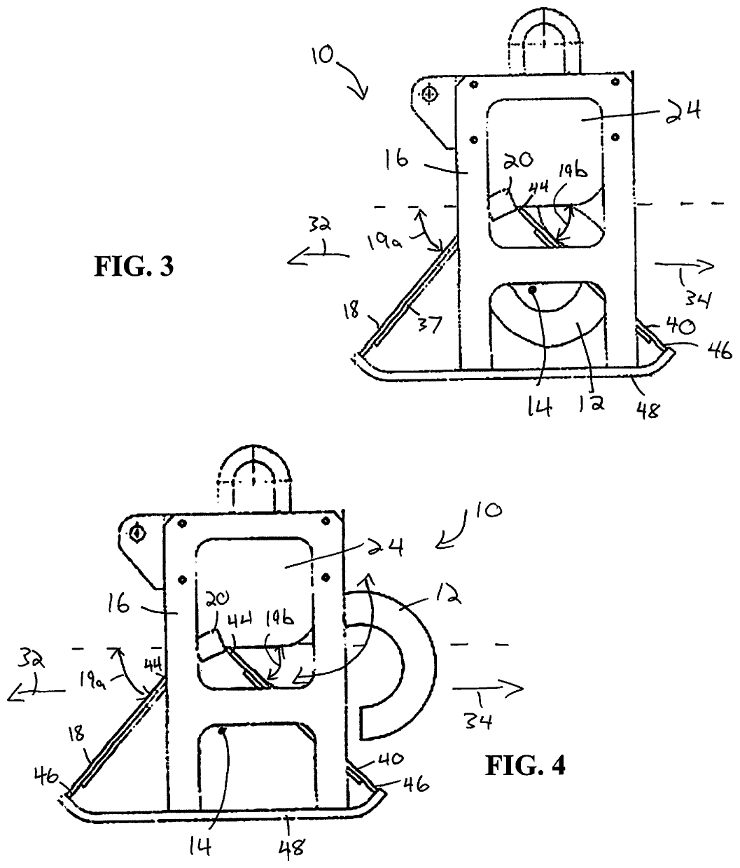

One aspect of the present disclosure is an automated lifting hook apparatus 10. One embodiment of an automated lifting hook apparatus 10 of the present disclosure is shown in FIGS. 1-4. The automated lifting hook apparatus 10 can include a hook housing 24, a hook member 12 movably connected to the hook housing 24 and moveable from a retracted position (shown in FIG. 4) to a hook position (shown in FIG. 3). In some embodiments, the hook member 12 can be pivotally or rotatably connected to the hook housing 24. In other embodiments, the hook member 12 can be positioned on a linear actuator that can move the hook member 12 linearly between the hook position and the retracted position. In some embodiments, the hook housing 24 of the lifting hook apparatus 10 can include control components and/or an actuation system for selectively moving the hook member 12 between the retracted position and the hook position.

The hook member 12 can define a hook engagement point 14 when the hook member 12 is in the hook position. The hook engagement point 14 can be a point of engagement between the hook and a lifting eyelet or lifting ring on a load to be lifted and can generally be located within a rounded portion of the hook member 12 when the hook member 12 is in the hook position. A guide frame 16 can be connected to the hook housing 24. In some embodiments, the hook housing 24 and the guide frame 16 can be integrally formed together in a single unitary piece or mold. The guide frame 16 in some embodiments can at least partially surround the hook engagement point 14. The guide frame 16 can include at least one guide plate 18 extending outward relative to the hook engagement point 14 of the hook member 12 and at a first downward angle 19a. In some embodiments, the apparatus 10 can further include a hook lifting ring 38 extending from the hook housing 24 or the guide frame 16 opposite the hook member 12 when the hook member is in the hook position. The hook lifting ring 38 can be used to lift and move the apparatus 10 via a crane or other lifting device.

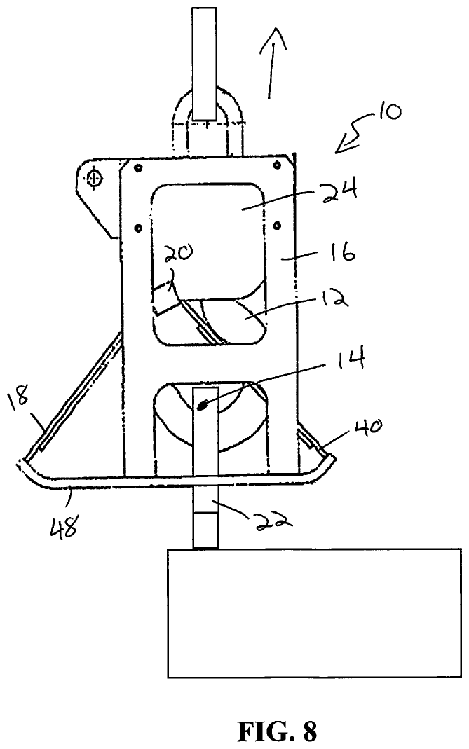

In some embodiments, the lifting hook apparatus 10 can further include a magnetic member 20 positioned on the lifting hook apparatus 10 adjacent the hook engagement point 14. The magnetic member 20 in some embodiments can be positioned just above the hook engagement point 14, such that as the apparatus 10 is lowered onto a lifting eyelet or lifting ring 22 of a load, when the magnetic member 20 attracts a top portion of an eyelet or lifting ring 22, as shown in FIG. 7, an opening of the eyelet or lifting ring 22 can be positioned to receive the hook member 12 when the hook member 12 moves to the hook position, as shown in FIG. 8. The guide frame 16 can at least partially surround the magnetic member 20 and the at least one guide plate 18 can extend outward from or relative to the magnetic member 20 and at the first downward angle 19a.

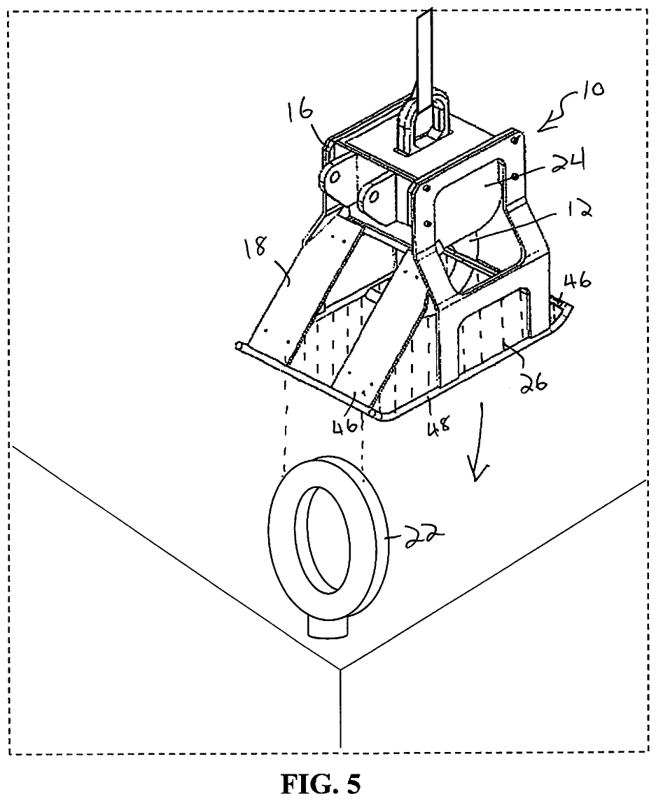

The guide frame 16 and the at least one guide plate 18 can be used to assist in engagement when using the automatic lifting hook apparatus 10. The guide frame 16 and the at least one guide plate 18 can help provide a larger initial target area 26 on the automated lifting hook 10 as the lifting hook 10 is being lowered onto an eyelet or lifting ring 22, as shown in FIG. 5. The target area 26 can generally be defined as the lower opening 35 or area defined by the guide frame 16 and/or the at least one guide plate 18 at the bottom of lifting hook apparatus 10. The downward angle 19a of the at least one guide plate 18 can be oriented to cause the apparatus 10 to move or slide on the eyelet or lifting ring 22 as the apparatus 10 is lowered onto the eyelet or lifting ring 22, if the eyelet or lifting ring 22 is not aligned with the magnetic member 20 or the hook engagement point 14. The movement of the apparatus relative to the eyelet or lifting ring 22 can help ensure that an opening of the eyelet or lifting ring 22 can be positioned generally at the hook engagement point 14.

In some embodiments, the guide frame 16 and the at least one guide plate 18 can be oriented to narrow gradually as the guide frame 16 guides an eyelet or lifting ring 22 toward the hook engagement point 14. The narrowing of the guide frame 16 via the at least one guide plate 18 can help significantly increase the initial contact or target area 26 between the lifting ring 22 and the lifting hook apparatus 10 for an operator to land on when lowering the lifting hook apparatus 10 onto an eyelet or lifting ring 22 via any sort of lifting mechanism such as a crane, or hoist. Increasing the target contact area 26 can help increase the efficiency and ease of capturing the lifting ring 22 with the lifting hook apparatus 10. In some embodiments, the guide frame 16 can provide a two dimensional initial target contact area 26 of between about 50 square inches and about 400 square inches. In some embodiments, the guide frame 16 can provide a two dimensional initial target contact area 26 of between about 100 square inches and about 200 square inches. In some embodiments, the guide frame 16 can provide an initial target contact area 14 of about 160 square inches.

In embodiments where the lifting hook apparatus 10 includes a magnetic member 20, the guide frame 16 can be oriented to guide magnetic member 20 via angled guide plate 18 toward the eyelet or lifting ring 22 on the load to be lifted. The combination of the guide frame 16, at least one guide plates 18, and the magnetic member 20 can significantly increase efficiency and ease for an operator in connecting lifting hook apparatuses 10 to lifting rings 22, either individually or when connecting multiple lifting hook apparatuses 10 to multiple corresponding lifting rings spaced apart from one another, for instance on a cargo vessel lid which is to be removed and/or placed on a cargo vessel with a device including multiple automated lifting hooks, as taught in U.S. Pat. No. 9,434,580. The apparatus 10 of the present disclosure can be used in any suitable lifting apparatus or to lift any suitable load wherein a lifting ring or eyelet is desired to be engaged or captured by an automated lifting hook 10.

As shown in FIGS. 1-4, in some embodiments, the motion of the hook member 12 can generally be described as moving in a forward direction 32 and a rearward direction 34 as the hook member 12 moves to the hook positon and the retracted position respectively. In some embodiments, the hook member 12 can move in a rotational or pivoting motion about hook housing 24 as opposed to a linear motion. Moving in a forward direction 32 or rear direction 34 can denote the generally horizontal component of the motion of the hook member 12 either in the forward direction 32 as the hook member 12 moves to the hook position, or the rear direction 34 as the hook member 12 moves to the retracted position.

In some embodiments, the guide frame 16 can include a first guide plate 18 and a second guide plate 40, the first guide plate 18 extending outward relative to the hook engagement point 14 of the hook member 12 in the forward direction 32 and at a downward angle 19a, the second guide plate 40 extending outward relative to the hook engagement point 14 of the hook member 12 in a rear direction 34 opposite the forward direction 32 and at a second downward angle 19b. In some embodiments, the first and second downward angles 19a and 19b can be substantially equal to one another. As such, in some embodiments, the apparatus 10 can include two guide plates 18 and 40 extending from the hook housing 24 and/or relative to the hook engagement point 14 in a forward direction 32 or rearward direction 34. Having guide plates 18 and 40 extending in both a forward and rearward direction 32 and 34 can allow the positioning of the apparatus 10 to be adjusted as the apparatus 10 is lowered onto a lifting eyelet or lifting ring 22 if the apparatus 10 is misaligned with the lifting eyelet or lifting ring 22 in either a forward direction 32 or a rearward direction 34. In other embodiments, guide frame 16 can include a single guide plate 18 extending in either the forward direction 24 or the rearward direction 34.

In some embodiments, the second or rear guide plate 40 can include a hook aperture 42, the hook member 12 passing through the hook aperture 42 as the hook member 12 moves from the retracted position to the hook position. As such, a rear or second guide plate 40 can allow for retraction of the hook member 12 through the rear or second guide plate 40. When the hook member 12 is in the retracted position, the apparatus 10 can be lowered onto a lifting ring or eyelet 22 such that the second or rear guide plate 40 can engage the eyelet or lifting ring 22 if the eyelet or lifting ring 22 is offset from the apparatus 10 in the rearward direction 34. In some embodiments, the first guide plate 18 can be said to extend outward from the hook engagement point 14 in a first or forward direction 32 at a first downward angle 19a and the second guide plate 40 can extend outward relative to the hook engagement point 14 in a second or rearward direction 34 opposite the first direction 32 and at a second downward angle 19b.

In some embodiments, the second or rear guide plate 40 can include a first rear guide plate portion 40a and a second rear guide plate portion 40b extending outward relative to the hook engagement point 14 of the hook member 12 in the rearward direction 34 and at a downward angle 19b, the first and second rear guide plate portions 40a and 40b oriented substantially parallel to one another. In such embodiments, the hook aperture 42 can be defined between the first and second guide plate portions 40a and 40b, wherein the hook member 12 extends through the hook aperture 42 between the rear guide plate portions 40a and 40b when the hook member 12 moves from the retracted position to the hook position.

In some embodiments, as shown in FIGS. 1 and 2, each of the first and second guide plates 18 and 40 have a proximal end 44 connected to or extending from the hook housing 24 and a distal end 46, wherein the distal ends 46 of the first and second guide plates 18 and 40 are connected to one another via a lower support frame 48. The distal ends 46 of the guide plates 18 and 40 and the lower support frame 48 can generally define the target contact area 26 when the apparatus 10 is being lowered onto an eyelet or lifting ring of a load. The lower support frame 48 can also provide for correction of the position of the apparatus 10 over the eyelet or lifting ring if the eyelet or lifting ring is offset in a lateral direction, or a direction generally perpendicular to the forward and rearward direction. As most eyelets or lifting rings are rounded, if an apex of the eyelet or lifting ring is within the target contact area 26 as the apparatus 10 is lowered onto the eyelet or lifting ring and a top portion of the eyelet or lifting ring contacts the lower support frame 48, the rounded shape of the eyelet or lifting ring can cause the apparatus 10 to move in a lateral direction via the support frame 48 to generally position the eyelet or lifting ring towards a center of the apparatus 10.

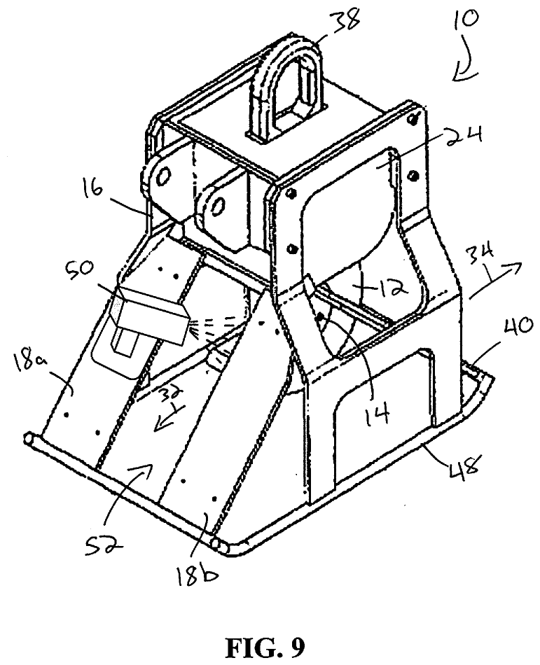

In some embodiments, as shown in FIG. 9, the apparatus 10 can further include a camera 50 mounted on one of the guide plates 18 or 40, the camera 50 oriented toward the hook engagement point 14 or pointed in a direction to view the hook engagement point 14, as the apparatus 10 is being lowered onto an eyelet or lifting ring of a load, the camera 50 can help an operator align the apparatus 10 over the eyelet or lifting ring such that an opening of an eyelet or lifting ring can generally be positioned at the hook engagement point 14. In some embodiments, as shown in FIG. 9, the guide plate 18 on which the camera 50 is mounted can include a camera aperture 52 defined in the guide plate 18. The camera 50 can be mounted on the guide plate 18 and oriented to view the hook engagement point 14 through the camera aperture 52 in the guide plate 18. In some embodiments, the camera 50 can be mounted on a guide plate 18 extending in the forward direction 32 from the hook engagement point 14 so that the camera 50 can have an appropriate angle to see movement of the hook member 12 and engagement or capture of the eyelet or lifting ring with the hook member 12. In some embodiments, guide plate 18 extending in the forward direction can include a first forward guide plate portion 18a and a second forward guide plate portion 18b which can be oriented substantially parallel to one another and the camera aperture 52 can be defined between the first and second forward guide plate portions 18a and 18b.

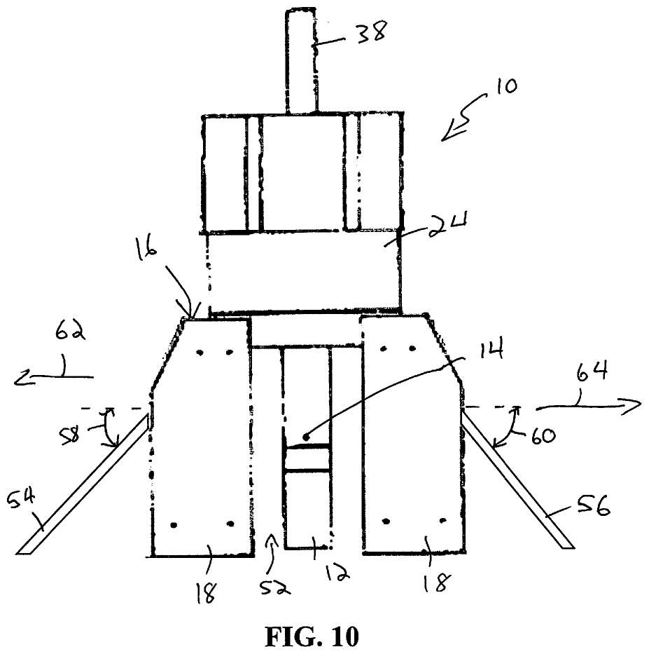

The guide frame 16 in some embodiments can form a funnel shaped design with multiple guide plates 18 extending radially outward from the hook engagement point 14 in various directions, including in a forward, backward, or either lateral direction, and at downward angles. A funnel shaped design can help further increase the target contact area 26 for the apparatus 10. As shown in FIGS. 10-13, in some embodiments, in addition to first and second guide plates 18 and 40 extending in first and second or forward and rear directions 32 and 34 respectively, the guide frame 16 can further include a third guide plate 54 extending outward from the hook engagement point 14 in a third direction 62 oriented substantially perpendicular to the first direction 32 and at a third downward angle 58. The third direction 62 can be described as a first lateral direction.

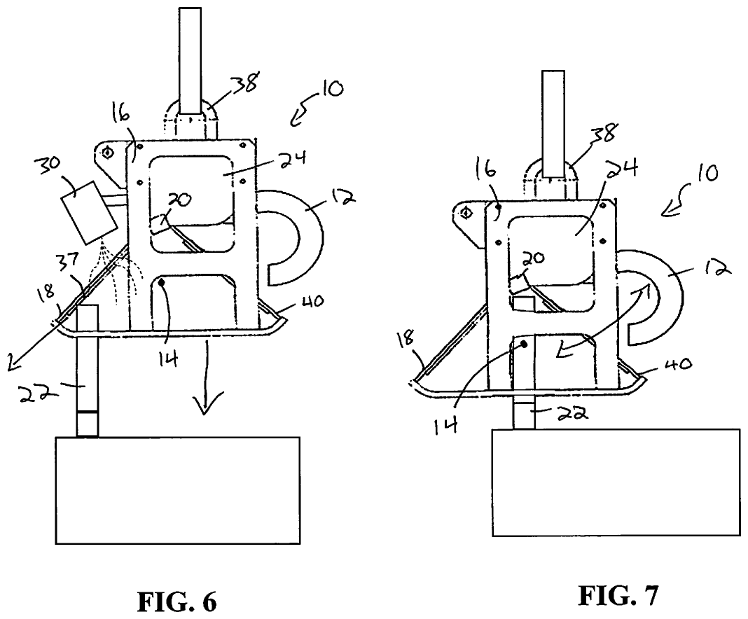

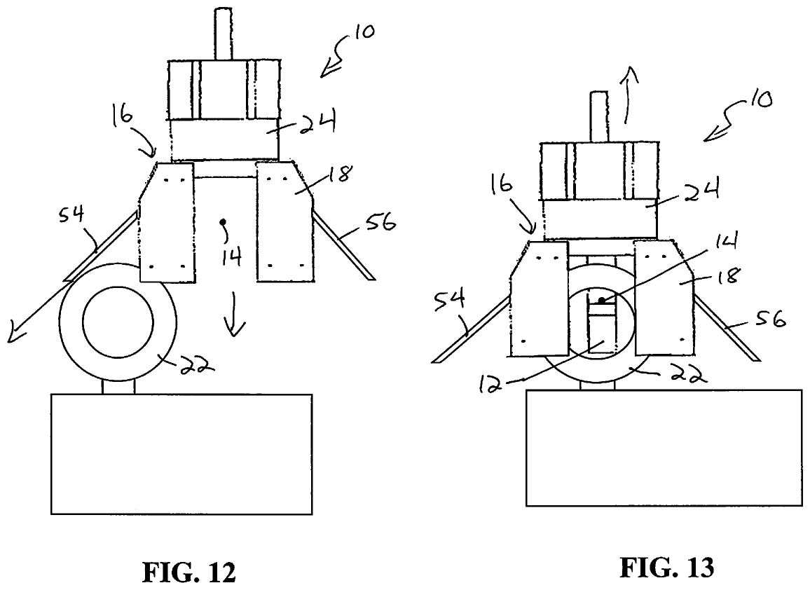

In some embodiments, the guide frame 16 can further include a fourth guide plate 56 extending outward from the hook engagement point 14 in a fourth lateral direction 62 oriented opposite the third lateral direction 64 and at a fourth downward angle 60. The fourth direction may be referred to as a second lateral direction. In some embodiments, the third and fourth downward angles 58 and 60 can be substantially equal to one another. The first, second, third and fourth guide plates 18, 40, 54, and 56 can form a funnel shape around the hook engagement point 14 to urge or cause the apparatus 10 to move relative to an eyelet or lifting ring 22 on a load as the apparatus 10 is lowered onto the eyelet or lifting ring 22 to help position the eyelet or lifting ring 22 near the hook engagement point 14 in the event the eyelet or lifting ring 22 is offset from the hook engagement point 14 in any of the first, second, third, or fourth directions 32, 34, 62, or 64 respectively. As shown in FIGS. 6 and 7, the first and second, or forward and rear, guide plates 18 and 40 can help make forward and rear, or longitudinal, adjustments as needed to the position of apparatus 10 over the eyelet or lifting ring 22. As shown in FIGS. 12-13, the third and fourth guide plates 54 and 56 can help make lateral adjustments to the position of the apparatus 10 over the eyelet or lifting ring 22.

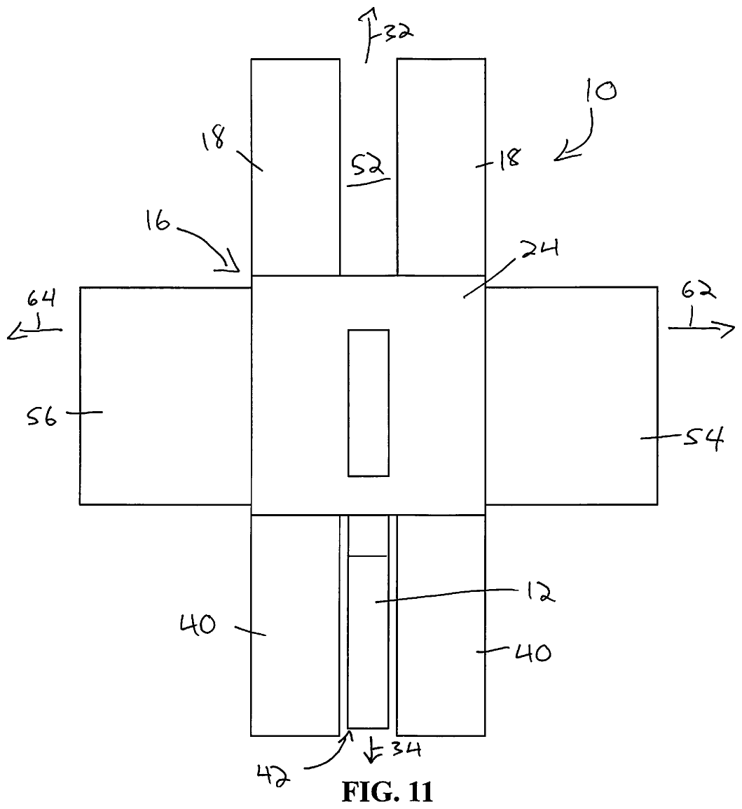

In some embodiments, the at least one guide plate 18 can extend in a generally outward radial direction relative to the hook engagement point 14. In some embodiments, the guide frame 16 of the apparatus 10 can include two guide plates 18 and 40 extending in opposite outward radial directions and at downward angles. In other embodiments, the guide frame 16 can include four guide plates 18, 40, 54, and 56 extending in outward symmetrical radial directions relative to the hook engagement point 14 and at downward angles, as shown in FIGS. 10-11.

Referring again to FIG. 2, in some embodiments the at least one guide plate 18 can include a first side 36 facing the engagement hook point 14. The first side 36 of the at least one guide plate 18 would potentially contact the lifting ring 22 on the load as the apparatus 10 was lowered onto the lifting ring 22. The apparatus 10 can further include a pad 37 positioned on the first side 36 of the at least one guide plate 18. The pad 37 can be made from a compressible material such as rubber or foam to help absorb any abrupt impact between the guide plate 18 and the lifting ring 22 while still allowing relative motion between the guide plate 18 and the lifting ring 22.

In some embodiments, the guide frame 16 and/or individual guide plates 18 on the guide frame 16 can be adjustable on the lifting hook 10 either manually or automatically. The guide frame 16 can be made from various suitable materials, or a combination of materials, including but not limited to metal, wood, plastic, composite, etc. The guide frame 16 can be manufactured in various shapes to accommodate a variety of lifting applications while still providing a larger initial target or contact area 26 which narrows or directs the lifting ring 22 toward the hook engagement point 14.

In some embodiments, a guide frame 16 could be utilized for a multiple hook embodiments, or in other words, a guide frame 16 could be configured to surround multiple lifting hooks designed to capture multiple lifting rings on a desired load 10.

Automated lifting hook apparatuses 10 of the present disclosure could be equipped with various forms of technology to assist in the lifting task being performed. Examples of such tech are as follows: lights, cameras, Lidar components, Radar components, limit switches, etc. The apparatus 10 of the present disclosure could also be equipped with various forms of technology that could provide feedback to the user regarding the operating environment such as wind speed, temperature, precipitation, pressure sensors, radioactivity, air quality etc. The above-mentioned components can be placed on various components of the lifting hook 10, including the hook housing 24, the guide frame 16, or one or more of the guide plates 18.

In some embodiments, the lid hook 10 can be equipped with a de-icing component 30, which can be utilized to melt snow or ice positioned on a lifting ring 22 and/or the surrounding area, which can help ensure a better engagement between the lifting hook apparatus 10 and the lifting ring 22. In one embodiment, as shown in FIG. 6 the de-icing component 30 can be an electric heater or a blower for blowing hot air over the lifting ring 22. In another embodiment, the de-icing component could be a de-icing compound that could be released or could coat one or more components of the lifting hook 10 making contact with the lifting ring 22, such as an underside of the at least one guide plates 18. The de-icing compound can be capable of melting any ice or snow present on the lifting ring 22. Having a de-icing component 30 on the lifting hook apparatus 10 can help prevent manual removal of the ice and snow on the lifting ring 22 by a worker or operator before the lifting hook apparatus 10 can be deployed to engage the lifting ring 22.

In some embodiments, the de-icing component 30 can be positioned on the guide frame 16 or the at least one guide plates 18, as shown in FIG. 6. For instance, a hot air blower could be positioned on a side or above the guide frame 16 and be oriented to blow hot air over the lifting ring 22, either around the side of the guide frame 16 or through slots or apertures between adjacent guide plates 18 on the guide frame 16. In other embodiments, the de-icing component 30 could be positioned on any other suitable structure, including the hook housing 24.

Thus, although there have been described particular embodiments of the present invention of a new and useful Automated Lifting Hook Apparatus with Guide, it is not intended that such references be construed as limitations upon the scope of this invention.

What is claimed is:

1. An automated lifting hook apparatus comprising:
a hook housing;
a hook member movably connected to the hook housing, the hook member moveable between a retracted position and a hook position, the hook member defining a hook engagement point when the hook member is in the hook position; and
a guide frame connected to the hook housing, the guide frame including at least one guide plate extending outward relative to the hook engagement point of the hook member in a first direction and at a downward angle.

2. The apparatus of claim 1, further comprising:
a magnetic member positioned on the hook housing adjacent the hook engagement point;
wherein the at least one guide plate extends outward relative to the magnetic member in the first direction and at the downward angle.

3. The apparatus of claim 1, wherein the guide plate includes a hook aperture defined in the guide plate, the hook member passing through the hook aperture as the hook member moves from the retracted position to the hook position.

4. The apparatus of claim 1, wherein the at least one guide plate includes a first guide plate portion and a second guide plate portion extending outward relative to the hook engagement point of the hook member in a first direction and at a downward direction, the first and second guide plate portions oriented substantially parallel to one another.

5. The apparatus of claim 4, further comprising a hook aperture defined between the first and second guide plate portions, wherein the hook member extends through the hook aperture when the hook member moves from the retracted position to the hook position.

6. The apparatus of claim 1, wherein the guide frame further comprises a second guide plate extending outward relative to the hook engagement point in a second direction opposite the first direction and at a second downward angle.

7. The apparatus of claim 6, wherein each of the first and second guide plates have a proximal end connected to the hook housing and a distal end, wherein the distal ends of the first and second guide plates are connected to one another via a support frame.

8. The apparatus of claim 6, wherein the guide frame further comprises a third guide plate extending outward from the hook engagement point in a third direction oriented substantially perpendicular to the first direction and at a third downward angle.

9. The apparatus of claim 8, wherein the guide frame further comprises a fourth guide plate extending outward from the hook engagement point in a fourth lateral direction oriented opposite the third lateral direction and at a fourth downward angle.

10. The apparatus of claim 9, wherein the first and second downward angles are substantially equal to one another and the third and fourth downward angles are substantially equal to one another.

11. The apparatus of claim 1, further comprising a camera mounted on the guide plate, the camera oriented toward the hook engagement point.

12. The apparatus of claim 11, wherein:
the guide plate includes a camera aperture defined in the guide plate, and
the camera is mounted on the guide plate and oriented to view the hook engagement point through the camera aperture.

13. The apparatus of claim 1, wherein the hook member is pivotally connected to the hook housing and can rotate between the hook position and the retracted position.

14. The apparatus of claim 1, wherein:
the at least one guide plate includes a first side facing the engagement hook point; and
the apparatus further comprises a pad positioned on the first side of the at least one guide plate.

15. An automated lifting hook apparatus comprising:
a hook housing;
a hook member pivotally connected to the hook housing, the hook member moveable between a retracted position and a hook position, the hook member defining a hook engagement point when the hook member is in the hook position; and
a guide frame connected to the hook housing, the guide frame including a plurality of guide plates extending radially outward relative to the hook engagement point of the hook member and in a downward direction.

16. The apparatus of claim 15, wherein the apparatus includes at least two guide plates extending in opposing radial directions relative to the hook engagement point.

17. The apparatus of claim 15, wherein the apparatus incudes at least four guide plates extending radially symmetrically relative to the hook engagement point.

18. The apparatus of claim 15, further comprising a camera mounted to one of the plurality of guide plates and oriented to view the hook engagement point.

19. An automated lifting hook apparatus comprising:
a hook housing;
a hook member pivotally connected to the hook housing, the hook member moveable in a forward direction from a retracted position to a hook position, the hook member defining a hook engagement point when the hook member is in the hook position; and
a guide frame connected to the hook housing, the guide frame including a first guide plate and a second guide plate, the first guide plate extending outward relative to the hook engagement point of the hook member in the forward direction and at a downward angle, the second guide plate extending outward relative to the hook engagement point of the hook member in a rear direction opposite the forward direction and at a second downward angle.

20. The apparatus of claim 19, wherein the second guide plate incudes a hook aperture, the hook member passing through the aperture as the hook member moves from the retracted position to the hook position.
